(19) United States
(12) Patent Application Publication
(10) Pub. No.: US 2019/0129383 A1
(43) Pub. Date: May 2, 2019

(54) 3D RENDER DATA PROCESSING

(71) Applicant: Hewlett-Packard Development Company, L.P., Houston, TX (US)

(72) Inventors: Jordi GONZALEZ ROGEL, Sant Cugat del Valles (ES); Sergio GONZALEZ, Sant Cugat del Valles (ES); Roger TARRES, Sant Cugat del Valles (ES)

(73) Assignee: Hewlett-Packard Development Company, L.P., Houston, TX (US)

(21) Appl. No.: 16/094,424

(22) PCT Filed: May 12, 2016
(86) PCT No.: PCT/US2016/032097

§ 371 Date: Oct. 17, 2018

(51) Int. Cl. G05B 19/4099; B33Y 50/00; G06T 19/20

(52) U.S. Cl. CPC G05B 19/4099; B33Y 50/00; G06T 2219/2016; G05B 2219/35134; G05B 2219/49007; G06T 19/20

(57) ABSTRACT

According to an example, a computing apparatus may include a processing device that may access a three-dimensional (3D) object model of a 3D object and determine whether 3D render data for an equivalent 3D object model has previously been processed, is scheduled to be processed, or is currently being processed, the equivalent 3D object model being equivalent to the accessed 3D object model. The processing device may assign 3D render data corresponding to the equivalent 3D object to the 3D object or may generate processed 3D render data for the 3D object using the accessed 3D object model depending upon whether 3D render data for an equivalent 3D object model has previously been processed, is scheduled to be processed, or is currently being processed.

### BACKGROUND

In three-dimensional (3D) printing, an additive printing process may be used to make three-dimensional solid parts from a digital model. The digital model may be rendered and a 3D printer may use the rendered digital model in forming the 3D solid parts. 3D printing may be used in rapid product prototyping, mold generation, mold master generation, and short run manufacturing. Some 3D printing techniques are considered additive processes because they involve the application of successive layers of material. This is unlike traditional machining processes, which often rely upon the removal of material to create the final part. In 3D printing, the building material may be cured or fused, which for some materials may be performed using heat-assisted extrusion, melting, or sintering, and for other materials, may be performed using digital light projection technology.

### BRIEF DESCRIPTION OF THE DRAWINGS

Features of the present disclosure are illustrated by way of example and not limited in the following figure(s), in which like numerals indicate like elements, in which:

FIG. 1 shows a simplified block diagram of an example computing apparatus;

FIG. 2 shows a simplified block diagram of another example computing apparatus;

FIGS. 3 and 4, respectively, depict example methods for processing a 3D object model of a 3D object for 3D print rendering; and

FIG. 5 shows an example process flow diagram of a manner in which processed data may be generated and/or assigned to a plurality of 3D object models.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

Disclosed herein are computing apparatuses, methods for implementing the computing apparatuses, and a computer readable medium on which is stored machine readable instructions for implementing the computing apparatuses. Particularly, for instance, the computing apparatuses disclosed herein may include a processing device that may access a 3D object model of a three-dimensional (3D) object and determine whether 3D render data for an equivalent 3D object model has previously been processed, is scheduled to be processed, or is currently being processed, the equivalent 3D object model being equivalent to the accessed 3D object model. The processing device may assign 3D render data corresponding to the equivalent 3D object to the 3D object or may generate processed 3D render data for the 3D object using the accessed 3D object model depending upon whether 3D render data for an equivalent 3D object model is available or is scheduled to be available. The terms “3D render data” may equivalently be “3D print render data” and may denote data that a 3D printer may use to print a 3D object. In one regard, the process of generating 3D render data may include a print rendering process of information, such as information contained in a 3D object model.

The computing apparatuses disclosed herein may reuse previously processed 3D render data for a 3D object to be printed instead of generating the processed 3D render data each time 3D render data for the 3D object is needed. One result of this reuse may be that additional processed 3D render data may not be generated for each 3D object to be printed and thus, the amount of disk space required for the processed 3D render data may be significantly smaller than would be required in instances in which processed 3D render data is generated for each of the 3D objects.

In addition, the computing apparatuses disclosed herein may include a plurality of processing devices, e.g., multiple cores in a processor, multiple processors, and combinations thereof. In instances in which processed 3D render data for multiple 3D objects are to be generated, the processing devices may generate the processed 3D render data in parallel with each other. As 3D object models may contain a large amount of information to be processed and as a large number of 3D objects may be processed for a single printing operation, the parallelization of the processing may result in significant time savings.

Through implementation of the computer apparatuses and methods disclosed herein, the amount of time required to assign/generate process 3D render data for a 3D object or for multiple 3D objects may significantly be reduced. In one regard, the computer apparatuses and methods disclosed herein may significantly improve the performance of the computer apparatuses in assigning/generating the process 3D render data as well as in rendering the process 3D render data. For instance, the computer apparatuses and methods disclosed herein may enable the computer apparatuses to operate in a more efficient manner as the computer apparatuses may process more data in a relatively shorter amount of time. Moreover, a 3D object or multiple 3D objects may be printed or otherwise formed using the rendered processed data for the 3D object or the multiple 3D objects.

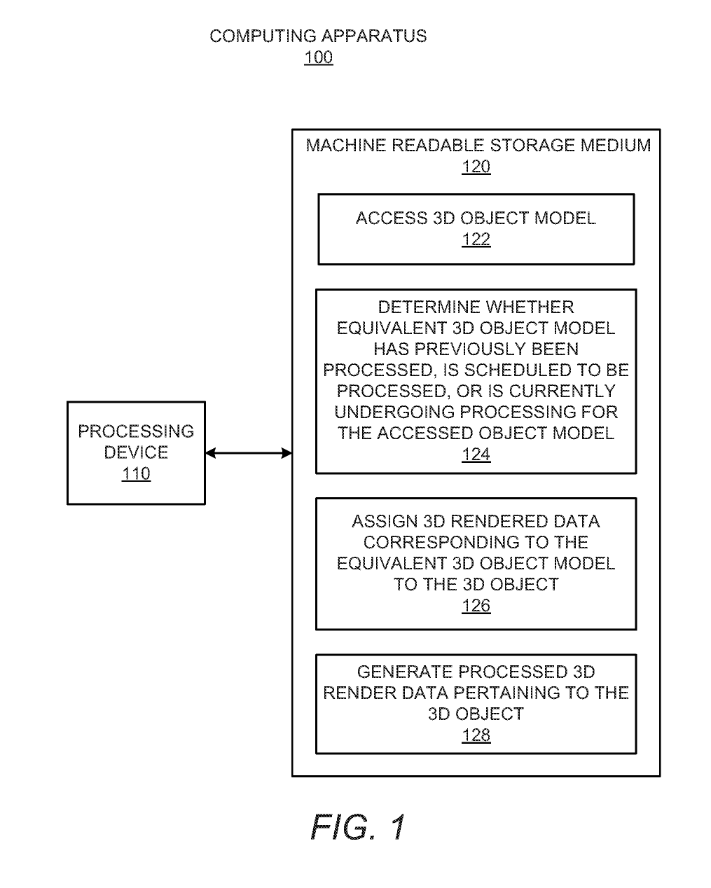

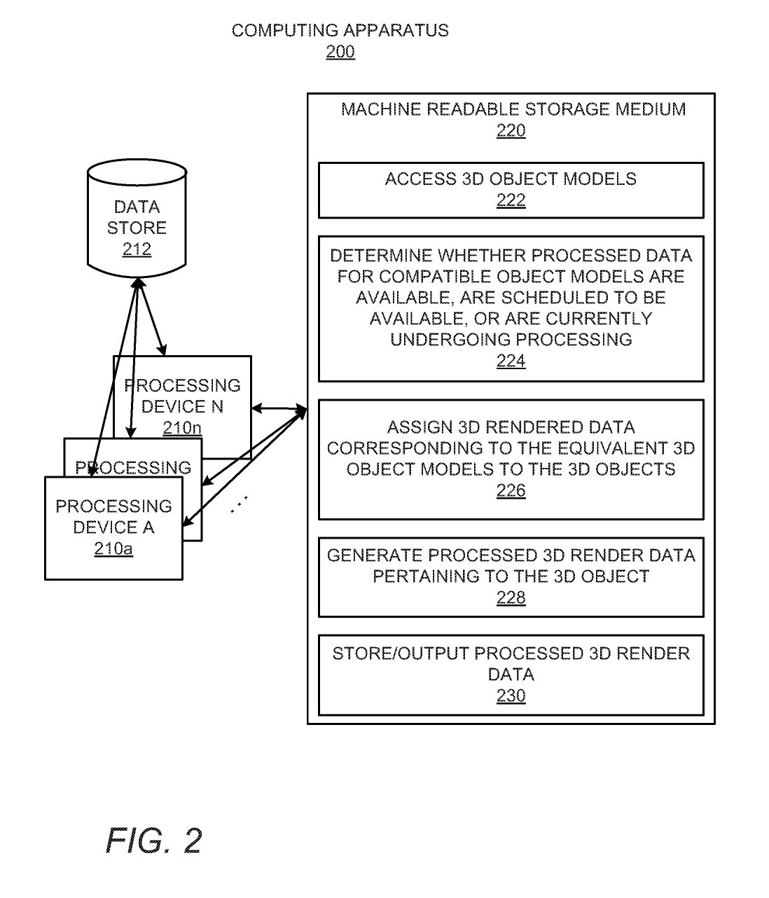

With reference to FIGS. 1 and 2, there are respectively shown simplified block diagrams of example computing apparatuses 100, 200. According to an example, the computing apparatuses 100, 200 may each be, for instance, a personal computer, a laptop computer, a server computer, or the like. In other examples, the computing apparatuses 100, 200 may each be implemented as part of a three-dimensional (3D) printer (not shown). For instance, either of the computing apparatuses 100 may be a command module or other control system of a 3D printer. It should be understood that the computing apparatuses 100 and 200 depicted in FIGS. 1 and 2 may include additional components and that some of the components described herein may be removed and/or modified without departing from scopes of the computing apparatuses 100 and 200 disclosed herein.

In FIG. 1, the computing apparatus 100 is shown as including a processing device 110, which may be a semiconductor-based microprocessor, a central processing unit (CPU), an application specific integrated circuit (ASIC), a multiple core microprocessor, and/or other hardware processing device. The computing apparatus 100 is also shown as including a machine readable storage medium 120, which may equivalently be termed a computer readable storage medium. The machine readable storage medium 120 may have stored thereon machine readable instructions 122-128 that the processing device 110 may execute.

More particularly, the processing device 110 may fetch, decode, and execute the instructions 122-128 to access a 3D object model of a 3D object 122, to determine whether 3D render data for an equivalent (or compatible) 3D object model has previously been processed, is scheduled to be processed, or is currently being processed 124, to assign 3D render data corresponding to the equivalent 3D object model to the 3D object 126, and to generate processed 3D render data pertaining to the 3D object using the accessed 3D object model 128. As an alternative or in addition to retrieving and executing instructions, the processing device 110 may include one or more electronic circuits that include components for performing the functionalities of the instructions 122-128.

In FIG. 2, the computing apparatus 200 is depicted as including a plurality of processing devices 210a-210n, in which the variable “n” is an integer value greater than one. Each of the processing devices 210a-210n may be a semiconductor-based microprocessor, a central processing unit (CPU), an application specific integrated circuit (ASIC), a multiple core microprocessor, and/or other hardware processing device. In other examples, each of the processing devices 210a-210n may be a core in a multiple core processor or in a plurality of multiple core processors. The computing apparatus 200 is also depicted as including a data store 212 upon which the processing devices 210a-210n may store data and from which the processing devices 210a-210n may retrieve data.

The processing devices 210a-210n are shown as being in communication with a machine readable storage medium 220, which may equivalently be termed a computer readable storage medium. The machine readable storage medium 220 may have stored thereon machine readable instructions 222-230 that the processing devices 210a-210n may execute individually or in parallel with respect to each other. More particularly, the processing device(s) 210a-210n may fetch, decode, and execute the instructions 222-230 to access 3D object models of 3D objects 222, to determine whether 3D render data for compatible 3D object models are available, are scheduled to be available, or are currently being processed 224, to assign 3D render data corresponding to the equivalent 3D object models to the 3D objects 226, to generate processed 3D render data pertaining to the 3D objects using the accessed 3D object models 228, and to store/output the processed 3D render data 230. As an alternative or in addition to retrieving and executing instructions, the processing devices 210a-210n may include one or more electronic circuits that include components for performing the functionalities of the instructions 222-230.

The machine readable storage mediums 120, 220 may each be any electronic, magnetic, optical, or other physical storage device that contains or stores executable instructions. Thus, the machine readable storage mediums 120, 220 may each be, for example, Random Access Memory (RAM), an Electrically Erasable Programmable Read-Only Memory (EEPROM), a storage device, an optical disc, and the like. The machine readable storage mediums 120, 220 may each be a non-transitory machine-readable storage medium, where the term “non-transitory” does not encompass transitory propagating signals.

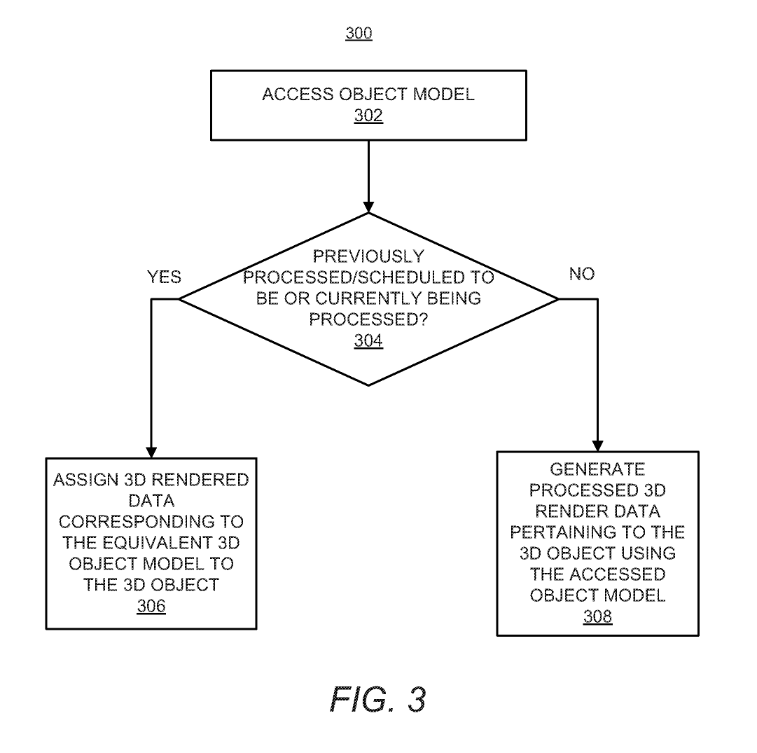

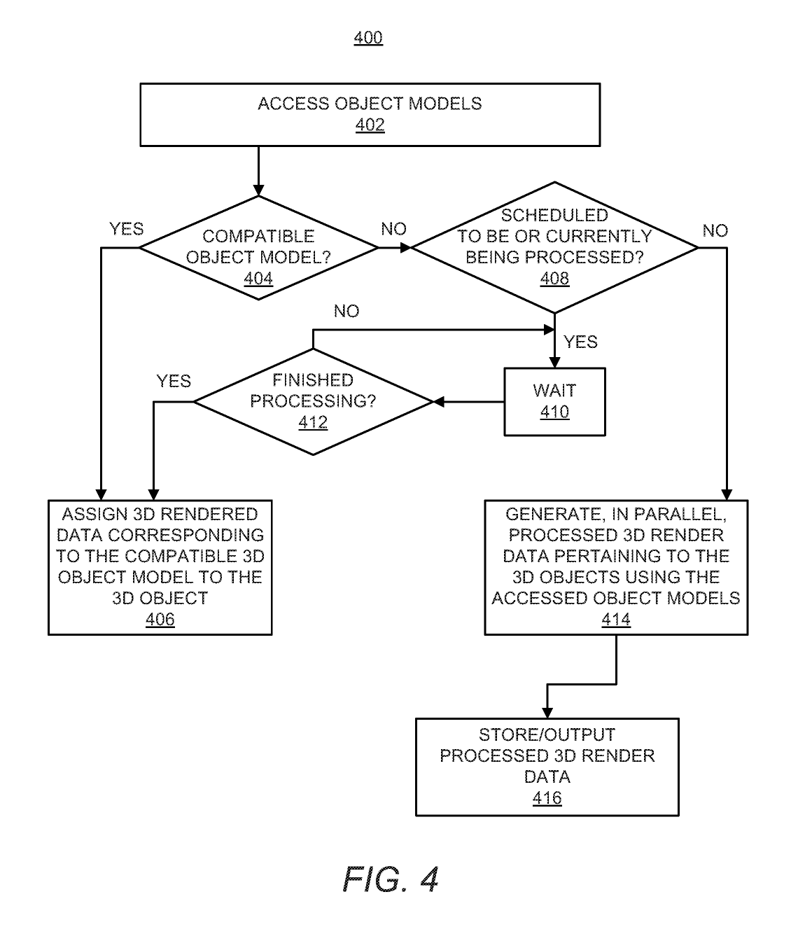

Various manners in which the computing apparatuses 100, 200 may be implemented are discussed in greater detail with respect to the methods 300 and 400 respectively depicted in FIGS. 3 and 4. Particularly, FIGS. 3 and 4, respectively, depict example methods 300 and 400 for processing 3D render data for a 3D object model or multiple 3D object models. It should be apparent to those of ordinary skill in the art that the methods 300 and 400 may represent generalized illustrations and that other operations may be added or existing operations may be removed, modified, or rearranged without departing from the scopes of the methods 300 and 400.

The descriptions of the methods 300 and 400 are made with reference to the computing apparatuses 100, 200 respectively depicted in FIGS. 1 and 2 for purposes of illustration. It should, however, be understood that computing apparatuses having other configurations may be implemented to perform either or both of the methods 300 and 400 without departing from the scopes of the methods 300 and 400.

With reference first to FIG. 3, at block 302, a 3D object model of a 3D object may be accessed. The 3D object may be an object that a 3D printer is to print or otherwise form. The 3D object model of the 3D object may include various information regarding the 3D object, such as the physical parameters of the 3D object to be printed. The physical parameters of the 3D object may include dimensions of the 3D object, internal features of the 3D object, color information of the 3D object, distances between boundaries of 3D objects, and the like. According to an example, the 3D object model may be in a 3MF file format, which is an Open Packaging Conventions (OPC) based formed set forth by the 3MF Consortium.

In any regard, a processing device 110, 210a, may execute the instructions 122, 222 to access the 3D object model at block 302. In one example, the 3D object model may be stored in a data store 212 to which the processing device 110, 210a may have access. In other examples, the processing device 110, 210a may access the 3D object model from an external source (not shown) or as data inputted by a user.

At block 304, a determination may be made as to whether 3D render data for an equivalent 3D object model has previously been processed, is scheduled to be processed, or is currently being processed, in which the equivalent 3D object model is equivalent to the accessed 3D object model. That is, for instance, the processing device 110, 210a may execute the instructions 124, 224 to determine whether a 3D object model that is equivalent to the accessed 3D object model has previously been processed for 3D print rendering. The processing device 110, 210a may also execute the instructions 124, 224 to determine whether a 3D object model that is equivalent to the accessed 3D object model is scheduled to be processed or is currently undergoing processing for 3D print rendering. The processing device 110, 210a may thus determine whether 3D render data for an equivalent 3D object model is available for reuse or will be available for reuse.

In an example, when a 3D object model is processed, e.g., rendered for 3D printing, the processed 3D render data for that 3D object model may be stored in a locally accessible data store 212 and/or in a data store that is accessible over a network. Thus, for instance, the processing device 110, 210a may store the processed 3D render data corresponding to the 3D object model in a data storage location following generation of the processed 3D render data. In addition, the processed 3D render data for the 3D object model may be stored with identifying information such as a file name, object name, physical parameters of the 3D object to which the 3D object model corresponds, or the like. In determining whether an equivalent 3D object model has previously been processed, the processing device 110, 210a may compare an identifier of the accessed 3D object model with the identifiers of the previously processed 3D object models to determine whether an equivalent 3D object model has previously been processed. If there is a match, the processing device 110, 210a may determine that an equivalent 3D object model has previously been processed for 3D print rendering.

In addition, or alternatively, the processing device 110, 210a may compare physical parameter information of the 3D object contained in the accessed 3D object model with physical parameter information identified in the previously processed 3D object models to determine if there is a match. According to an example, the processing device 110, 210a may determine that a match exists if the physical parameters identified in the previously processed 3D object model are equivalent to the physical parameters identified in the accessed 3D object model. That is, for instance, the processing device 110, 210a may determine that a match exists if the physical parameters identified in the previously processed 3D object model have a common scaling and orientation to the physical parameters identified in the accessed 3D object model. However, for instance, if the scaling is equivalent but the orientations differ, the processing device 110, 210a may determine that the previously processed 3D object model does not match and is thus not equivalent to the accessed 3D object model. Moreover, if there is a translation in the position of the previously processed 3D object model and the accessed 3D object model, the processing device 110, 210a may still determine that a match exists. The processing device 110, 210a may determine that compatibility exists when the conditions above are met if the format of the accessed 3D object model is raster based.

However, in instances in which the format of the accessed 3D object model is based on a set of polygon slices, the processing device 110, 210a may determine that compatibility exists even when there is a difference in translation or scaling and/or rotation in the horizontal plane. Scaling or rotation involving the vertical axis may, however, break the compatibility.

In another example, when a 3D object model is scheduled to be or is currently being processed for 3D print rendering, information pertaining to the scheduled or current processing may be stored in a locally accessible data store 212 and/or in a data store that is accessible over a network. Thus, for instance, the processing device 110, 210a may store this information in a data storage location prior to and during generation of the processed data. In addition, this information may be stored with identifying information such as a file name, object name, physical parameters of the 3D object to which the 3D object model corresponds, or the like. In determining whether an equivalent 3D object model is scheduled to be or is currently being processed, the processing device 110, 210a may compare an identifier of the accessed 3D object model with the identifiers of equivalent 3D object models that are scheduled to be or are currently being processed. If there is a match, the processing device 110, 210a may determine that an equivalent 3D object model is scheduled to be or is currently undergoing processing for 3D print rendering. The processing device 110, 210a may also determine whether there is match in the other manners discussed above.

In response to a determination at block 304 that an equivalent 3D object model has previously been processed, is scheduled to be processed, or is currently being processed, processed 3D render data corresponding to the equivalent 3D object model may be assigned to the 3D object as indicated at block 306. For instance, the processing device 110, 210a may execute the instructions 126, 226 to assign the processed 3D render data corresponding to the previous processing for the equivalent 3D object model to the matching 3D object. In another example in which the processed 3D render data for the equivalent 3D object model is scheduled to be processed or is currently being processed, the processing device 110, 210a may wait until the processed 3D render data for the equivalent 3D object model has been generated and may assign the processed 3D render data for the equivalent 3D object model to the 3D object.

However, in response to a determination at block 304 that 3D render data for an equivalent 3D object model has not previously been processed, is not scheduled to be processed, or is not currently being processed, processed 3D render data pertaining to the 3D object may be generated using the accessed 3D object model as indicated at block 308. For instance, the processing device 110, 210a may execute the instructions 128, 228 to generate the processed 3D render data corresponding to the accessed 3D object model of the 3D object. The processing device 110, 210a may generate the processed 3D render data for the accessed 3D object model by processing physical parameters of the 3D object identified in the 3D object model to determine values of the physical parameters. In other words, the processing device 110, 210a may generate the processed 3D data by extracting the physical parameters of the 3D object contained in the 3D object model such that the physical parameters may be in a format to be rendered for 3D printing.

With reference now to FIG. 4, at block 402, 3D object models of a plurality of 3D objects may be accessed. The 3D objects may be objects that a 3D printer is to print or otherwise form either individually or as part of a batch forming process. The 3D object models of the 3D objects may include various information regarding the 3D objects such as the physical parameters of the 3D objects. The physical parameters of a 3D object may include dimensions of the 3D object, internal features of the 3D object, color information of the 3D object, distances between boundaries of 3D objects, and the like. According to an example, the 3D object models may each be in the 3MF file format

In any regard, a processing device 210a or multiple processing devices 210a-210n may execute the instructions 222 to access the 3D object models at block 402. In one example, the 3D object models may be stored in a data store 212 to which the processing device 210a-210n may have access. In other examples, the processing devices 210a-210n may access the 3D object models from an external source (not shown) or as data inputted by a user. According to an example, a plurality of the processing devices 210a-210n may access a respective one of the 3D object models.

At block 404, a determination may be made as to whether 3D render data for compatible 3D object models are available for the accessed 3D object models. That is, for instance, the processing device(s) 210a-210n may execute the instructions 224 to determine, for each of the accessed 3D object models, whether a 3D object model that is compatible to the accessed 3D object model has previously been processed for 3D print rendering. The processing devices 210a-210n may also determine whether processed 3D render data for compatible 3D object models are available for reuse.

In an example, the processing devices 210a-210n may make the determination as to whether 3D render data for a compatible 3D object model has previously been processed for a respective 3D object model. In addition, the processing devices 210a-210n may make these determinations in parallel with each other to thus minimize or reduce the amount of time required to make these determinations.

In any regard, processed 3D render data for 3D object models may be stored in a locally accessible data store 212 and/or in a data store that is accessible over a network as discussed above with respect to the method 300. As also discussed above, the processed 3D render data for the 3D object models may be stored with identifying information such as file names, object names, physical parameters of the 3D objects to which the 3D object models correspond, or the like. In determining whether processed 3D render data for a compatible 3D object model has previously been processed for 3D print rendering, the processing devices 210a-210n may compare identifiers of the accessed 3D object models with the identifiers of the previously processed 3D object models to determine whether an equivalent 3D object model has previously been processed. If there is a match, the processing devices 210a-210n may determine that a compatible 3D object model has previously been processed for 3D print rendering and that the processed data for that compatible 3D object model is available.

In addition, or alternatively, the processing devices 210a-210n may compare physical parameter information of the 3D objects contained in the accessed 3D object models with physical parameter information identified in the previously processed 3D object models to determine if there are matches. According to an example, the processing devices 210a-210n may determine that a match exists if the physical parameters identified in the previously processed 3D object model are equivalent to the physical parameters identified in the accessed 3D object model. That is, for instance, the processing devices 210a-210n may determine that a match exists if the physical parameters identified in the previously processed 3D object model have a common scaling and orientation to the physical parameters identified in the accessed 3D object model. However, for instance, if the scaling is equivalent but the orientations differ, the processing devices 210a-210n may determine that the previously processed 3D object model does not match and is thus not equivalent to the accessed 3D object model. Moreover, if there is a translation in the position of the previously processed 3D object model and the accessed 3D object model, the processing devices 210a-210n may still determine that a match exists. The processing devices 210a-210n may determine that compatibility exists when the conditions above are met if the format of the accessed 3D object model is raster based.

However, in instances in which the format of the accessed 3D object model is based on a set of polygon slices, the processing devices 210a-210b may determine that compatibility exists even when there is a difference in translation or scaling and/or rotation in the horizontal plane. Scaling or rotation involving the vertical axis may however break the compatibility.

For each of the accessed 3D object models for which a determination at block 404 has been made that 3D render data for a compatible 3D object model is available, the 3D render data for the compatible 3D object model may be assigned to the 3D object as indicated at block 406. For instance, the processing devices 210a-210n may execute the instructions 226 to assign the processed 3D render data corresponding to the compatible 3D object models to the matching 3D objects. The assignment may include storage of a correlation between the assigned 3D render data for the compatible 3D object model and the accessed 3D object model in a data storage location. Additional information may also be stored with the assignment, such as a transformation pertaining to the accessed 3D object model from the compatible 3D object model. The transformation may include, for instance, differences in rotation, scaling, orientation, translation, combinations thereof, etc.

However, for each of the accessed 3D object models for which a determination at block 404 has been made that 3D render data for a compatible 3D object model is not available, a determination may be made as to whether a compatible 3D object model is scheduled to be or is currently being processed for 3D print rendering, as indicated at block 408. In response to a determination that a compatible 3D object model is scheduled to be or is currently being processed for 3D print rendering, the processing device 210a may wait for a predetermined period of time, which may be user-defined, as indicated at block 410. In addition, a determination may be made at block 412 as to whether the processing has finished. In response to a determination that the processing has not finished, blocks 410 and 412 may be repeated. Moreover, blocks 410 and 412 may be repeated until a determination is made that the processing for the equivalent 3D object model has finished and each of the accessed 3D object models for which a determination at block 412 has been made that the processed 3D render data for a compatible 3D object model has finished, the processed 3D render data for the compatible 3D object model may be assigned to the 3D object as indicated at block 406.

According to an example, blocks 402-412 may be performed in parallel by a plurality of the processing devices 210a-210n. That is, a first processing device 210a may perform blocks 402-412 for a first 3D object model, a second processing device 210b may concurrently perform blocks 402-412 for a second 3D object model, and so forth.

With reference back to block 408, in response to a determination that a compatible 3D object model is not scheduled to be processed or is not currently undergoing processing for 3D print rendering, processed 3D render data pertaining to the 3D object may be generated using the accessed 3D object models as indicated at block 414. For instance, the processing devices 210a-210n may execute the instructions 228 to generate the processed 3D render data pertaining to the 3D objects using the accessed 3D object models of the 3D objects. The processing devices 210a-210n may generate the processed 3D render data for the accessed 3D object models by processing physical parameters of the 3D objects identified in the 3D object models to determine values of the physical parameters. In other words, the processing devices 210a-210n may generate the processed 3D render data by extracting the physical parameters of the 3D objects contained in the 3D object models such that the physical parameters may be in a format to be rendered for 3D printing.

According to an example, the processing devices 210a-210n may generate processed data for a plurality of 3D object models in parallel with each other. Thus, for instance, a first processing device 210a may generate processed 3D render data for one of the 3D object models while a second processing device 210b generates processed data for another one of the 3D object models. In one regard, the amount of time required to generate the processed data for multiple 3D object models may thus be reduced as compared with serially generating the processed data for the 3D object models.

At block 416, the processed 3D render data may be stored and/or outputted. For instance, the processing devices 210a-210n may execute the instructions 230 to store the processed 3D render data generated at block 414 in a local storage location, such as the data store 212, and/or in a remote storage location. The processing devices 210a-210n may additionally or alternatively output the rendered data to a 3D printer such that the 3D printer may employ the rendered data to print the 3D objects individually or as a batch.

Additionally, in examples in which the computing apparatus 200 is part of a 3D printer, the processing devices 210a-210n may control the 3D printer to print the 3D objects using the rendered data for the plurality of 3D objects.

Some or all of the operations set forth in the methods 300 and 400 may be contained as utilities, programs, or subprograms, in any desired computer accessible medium. In addition, the methods 300 and 400 may be embodied by computer programs, which may exist in a variety of forms both active and inactive. For example, they may exist as machine readable instructions, including source code, object code, executable code or other formats. Any of the above may be embodied on a non-transitory computer readable storage medium. Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

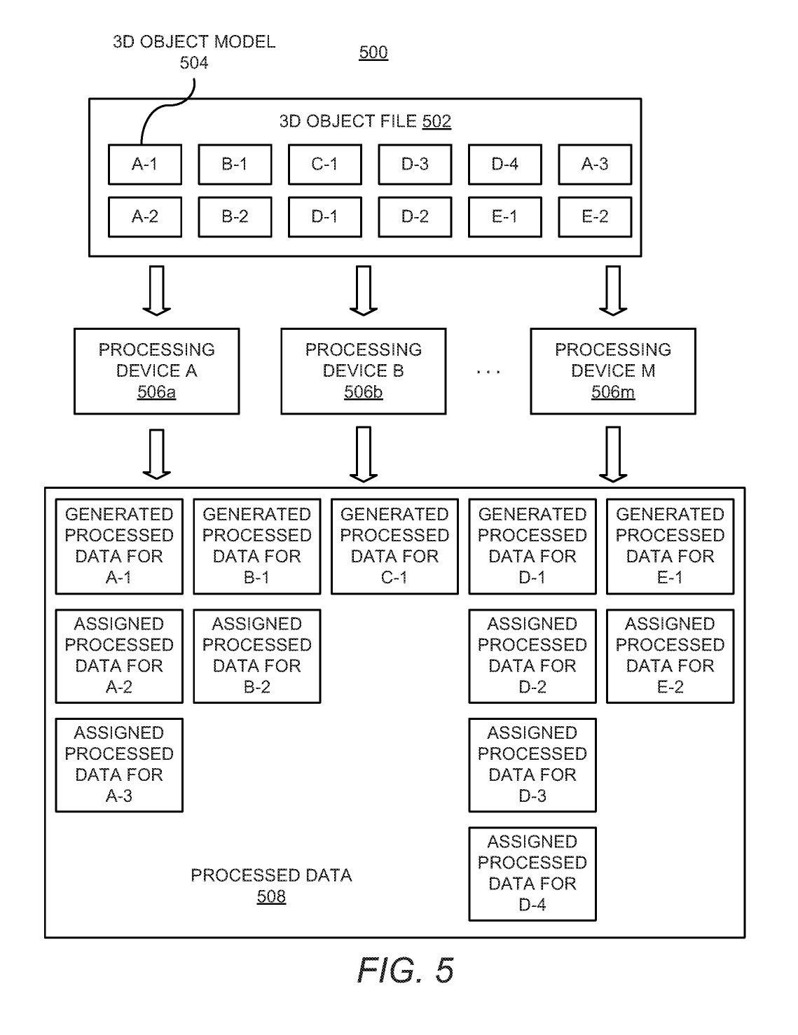

Turning now to FIG. 5, there is shown an example process flow diagram 500 of a manner in which processed data may be generated and/or assigned to a plurality of 3D object models. As shown, a 3D object file 502 may include a plurality of 3D object models 504 of 3D objects that are to be rendered for 3D printing. Each of the 3D object models 504 may correspond to a respective 3D object to be 3D printed and the 3D object models 504 having the same letter designation may be compatible with each other. Thus, for instance, each of the 3D object models 504 labeled A-1, A-2, and A-3 may be compatible with each other, e.g., may be grouped together as having the same shapes. However, compatible 3D object models 504 may have different parameters with respect to each other, such as different orientations, different translations, different rotations, different orientations, combinations thereof, or the like.

As also shown, multiple processing devices 506a-506m, in which the variable “m” may represent an integer greater than one, may access the 3D object files 504. Similarly to the processing devices 210a-210n discussed above, the processing devices 506a-506m may be multiple microprocessors and/or multiple cores in a multi-core processor. In any regard, the processing devices 506a-506m may process multiple ones of the 3D object models 504 in parallel to determine whether an equivalent or compatible 3D object model has previously been processed for each of the multiple ones of the 3D object models 504. The processing devices 506a-506m may also determine whether an equivalent or compatible 3D object model is scheduled to be or is currently being processed for 3D print rendering. According to an example, the processing devices 506a-506m may group the 3D object models 504 together prior to processing according to their respective compatibilities. That is, the processing devices 506a-506m may determine that a first set of 3D object models 504 are compatible with each other, e.g., A-1, A-2, and A-3. In this example, each of the groups of 3D object models 504 may be assigned to a respective one of the processing devices 506a-506m for processing. That is, a first one 506a of the processing devices 506a-506m may be assigned to process the 3D object models 504 in a first group, a second one 506b of the processing devices 506a-506m may be assigned to process the 3D object models 504 in a second group, and so forth.

According to an example, the processing devices 506a-506m may determine whether to generate the processed 3D render data for the 3D object models 504 or to assign previously generated 3D render data for the 3D object models 504. As discussed above, a processing device 506a may determine, for a 3D object model, whether processed 3D render data for an equivalent or compatible 3D object model has been generated, is scheduled to be generated, or is currently being processed. If so, the processing device 506 may either assign or wait to assign the processed 3D render data generated for the equivalent or compatible 3D object model to the 3D object model 504. Thus, for instance, the processing device 506a may determine that processed 3D render data from an equivalent 3D object model for a first 3D object model A-1 is not available and that the processed data is not scheduled to be or is not currently being generated. In this example, the processing device 506a may generate the processed 3D render data for the first 3D object using the first 3D object model A-1 and may store the processed data 508.

However, when the processing device 506a processes a second 3D object model A-2 that is equivalent to or compatible with the first 3D object model A-1, the processing device 506a may determine that processed 3D render data for the equivalent or compatible 3D object model A-1 is available. In addition, the processing device 506 may assign the processed 3D render data from the first 3D object model A-1 to the second 3D object model A-2. In other words, the processing device 506 may store a correlation between the processed 3D render data of the first 3D object model A-1 and the second 3D object model A-2. In addition, the processing device 506 may store an indication of transformation differences, if any, between the first 3D object model A—and the second 3D object model A-2. The transformation differences may include, for instance, differences in rotation, scaling, translation, combinations thereof, etc.

The processing devices 506a-506m may perform similar operations for the remaining 3D object models 504. As a result, the processed data 508 may include either generated or assigned processed 3D render data for each of the 3D object models 504 as shown in FIG. 5. In addition, the processed data 508 may include transformations between the assigned and generated processed 3D render data. During printing, the transformations identified with the assigned processed data may be taken into consideration to thus enable the 3D objects to be printed or otherwise formed accurately.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure. What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A computing apparatus comprising:
a processing device;
a machine readable storage medium on which is stored instructions that when executed by the processing device, cause the processing device to:
access a three-dimensional (3D) object model of a 3D object;
determine whether 3D render data for an equivalent 3D object model has previously been processed, is scheduled to be processed, or is currently being processed, the equivalent 3D object model being equivalent to the accessed 3D object model;
in response to a determination that 3D render data for the equivalent 3D object model has previously been processed, is scheduled to be processed, or is currently being process, assign the 3D render data corresponding to the equivalent 3D object model to the 3D object; and
in response to a determination that 3D render data for an equivalent 3D object model has not been previously processed, is not scheduled to be processed, or is not currently being processed, generate processed 3D render data pertaining to the 3D object using the accessed 3D object model.

2. The computing apparatus according to claim 1, wherein the instructions are further to cause the processing device to generate the processed 3D render data for the 3D object by processing physical parameters of the 3D object identified in the 3D object model to determine values of the physical parameters.

3. The computing apparatus according to claim 1, wherein the instructions are further to cause the processing device to determine that the equivalent 3D object model is equivalent to the accessed 3D object model in response to the equivalent 3D object model identifying a common scaling and orientation to the accessed 3D object model.

4. The computing apparatus according to claim 3, wherein the instructions are further to cause the processing device to determine that the equivalent 3D object model is equivalent to the accessed 3D object model in response to the equivalent 3D object model identifying a different translation with respect to the accessed 3D object model.

5. The computing apparatus according to claim 1, wherein the instructions are further to cause the processing device to:
store the generated processed 3D render data pertaining to the 3D object in a data store; and
store a correlation between the assigned 3D render data for the compatible 3D object model and the accessed 3D object model and a transformation pertaining to the accessed 3D object model from the compatible 3D object model in the data store.

6. The computing apparatus according to claim 1, wherein the instructions are further to cause the processing device to:
access 3D object models of a plurality of 3D objects;
for each 3D object of the plurality of 3D objects,
determine whether 3D render data for an equivalent 3D object model has previously been processed, is scheduled to be processed, or is currently being processed, the equivalent 3D object model being equivalent to an accessed 3D object model;
in response to a determination that 3D render data for the equivalent 3D object model has previously been processed, is scheduled to be processed, or is currently being processed, assign the 3D render data corresponding to the equivalent 3D object model to the 3D object; and
in response to a determination that 3D render data for an equivalent 3D object model has not been previously processed, is not scheduled to be processed, or is not currently being processed, generate processed 3D render data pertaining to the 3D object using the accessed 3D object model.

7. The computing apparatus according to claim 6, wherein the computing apparatus comprises a plurality of processing devices and wherein the instructions are to cause the plurality of processing devices to generate the processed 3D render data for multiple accessed 3D object models of the plurality of 3D objects in parallel.

8. A method comprising:
accessing a three-dimensional (3D) object model of a 3D object;
determining whether 3D rendered data for a compatible 3D object model is available, is scheduled to be available, or is currently being processed, the compatible 3D object model being compatible to the accessed 3D object model of the 3D object;
in response to a determination that the 3D rendered data for a compatible 3D object model is available, is scheduled to be available, or is currently being processed, assigning the 3D rendered data for the compatible 3D object model to the 3D object; and
in response to a determination that 3D rendered data for a compatible 3D object model is not available, is not scheduled to be available, or is not currently being processed, generating processed 3D render data pertaining to the 3D object using the accessed 3D object model of the 3D object.

9. The method according to claim 8, further comprising:
accessing 3D object models of a plurality of 3D objects;
for each 3D object of the plurality of 3D objects,
determine whether 3D render data for 3D print rendering for a compatible 3D object model is available, is scheduled to be available, or is currently being processed, the compatible 3D object model being compatible to the accessed 3D object model of the 3D object;
in response to a determination that the 3D render data for a compatible 3D object model is available, is scheduled to be available, or is currently being processed, assigning the 3D render data for the compatible 3D object model to the 3D object; and
in response to a determination that 3D render data for a compatible 3D object model is not available, is not scheduled to be available, or is not currently being processed, generating processed 3D render data pertaining to the 3D object using the accessed 3D object model of the 3D object.

10. The method according to claim 9, further comprising:
generating, in parallel by a plurality of processing devices, the processed 3D render data for multiple 3D objects of the plurality of 3D objects.

11. The method according to claim 9, further comprising:
storing the generated processed 3D render data pertaining to the 3D object in a data store; and
storing a correlation between the assigned 3D rendered data for the compatible 3D object model and the accessed 3D object model and a transformation pertaining to the accessed 3D object model from the compatible 3D object model in the data store.

12. The method according to claim 10, wherein determining whether a 3D object model is compatible to the accessed 3D object model comprises determining that a 3D object model is compatible to the accessed 3D object model in response to the 3D object model identifying a same scaling and orientation as the accessed 3D object model.

13. A non-transitory computer readable medium on which is stored machine readable instructions that when executed by a processing device, cause the processing device to:
access three-dimensional (3D) object models of a plurality of 3D objects;
for each 3D object of the plurality of 3D objects,
determine whether 3D render data for an equivalent 3D object model is available, is scheduled to be available, or is currently being processed, the equivalent 3D object model identifying physical parameters that are equivalent to physical parameters identified in the accessed 3D object model;
in response to a determination that the 3D render data for the equivalent 3D object model is available, is scheduled to be available, or is currently being processed, assign the 3D render data for the equivalent 3D object model to the 3D object; and
in response to a determination that the 3D render data for an equivalent 3D object model is not available, is not scheduled to be available, or is not currently being processed, generate processed 3D render data pertaining to the 3D object using the accessed 3D object model of the 3D object.

14. The non-transitory computer readable medium according to claim 13, wherein the machine readable instructions are further to cause the processing device to:
generate, in parallel by a plurality of processing devices, the processed 3D render data for multiple 3D objects of the plurality of 3D objects.

15. The non-transitory computer readable medium according to claim 13, wherein the machine readable instructions are further to cause the processing device to:
store the generated processed 3D render data pertaining to the 3D objects in a data store; and
store correlations between the assigned 3D rendered data for the compatible 3D object models and the accessed 3D object models and respective transformations pertaining to the accessed 3D object models from the compatible 3D object models in the data store.
